(19) United States
(12) Patent Application Publication
(10) Pub. No.: US 2019/0002048 A1
(43) Pub. Date: Jan. 3, 2019

(54) HEIGHT ADJUSTABLE SEAT POST

(71) Applicant: Crank Brothers, Inc., Laguna Beach, CA (US)

(72) Inventors: Carl Winefordner, Laguna Beach, CA (US); Frank Hermansen, Laguna Beach, CA (US)

(21) Appl. No.: 15/637,150

(22) Filed: Jun. 29, 2017

(51) Int. Cl. B62J 1/08; B62J 1/06; B62K 19/36

(52) U.S. Cl. CPC B62J 1/08; B62J 1/00; B62K 19/36; B62J 1/06

(57) ABSTRACT

A height adjustable seat post including a housing suitable to be inserted into a seat tube of a bicycle frame, and a quill including a head connectable to the rails of a bicycle saddle. The quill is slidably associated to the housing in order to be selectively translated from at least an upper position and a lower position, respectively corresponding to at least upper height saddle position and a lower height saddle position. The seat post includes at least a slot associated to the housing or to the quill, and at least a pin associated to the quill or to the housing; the pin is slidably engaged within the slot and it is selectively engageable into a first contour of the slot, corresponding to the upper position of the quill, and into a second contour of the slot, corresponding to the lower position of the quill.

### FIELD OF THE INVENTION

The present invention relates to a height adjustable seat post.

### BACKGROUND OF THE INVENTION

Height adjustable seat posts have become commonplace on mountain bikes, and they are beginning to be used on other categories of bicycles such as road bikes, commuter bikes, e-bikes and cyclocross bikes.

On mountain bikes, the biggest advantage of using height adjustable seat posts is that descending steep terrains is safer and easier by lowering the saddle height.

However, many other advantages can be achieved by using an adjustable height seat post on any kind of bicycle.

For example, by lowering the saddle just before stopping, the rider's feet can reach the ground while being seated: this makes the stop more comfortable, as well as easier to start riding again.

Furthermore, when descending at high speeds on any surface, it is more stable and safer to be seated at a lower position; this applies, for example, to road bikes traveling fast down a mountain pass on pavement.

Also, lowering the saddle lowers the rider's center of gravity which allows faster braking without the bicycle flipping over forwards.

In addition, when riding for long periods of time, it feels good to occasionally change riding positions by lowering and rising the saddle, thus relieving pressure on certain body parts.

However, up to now height adjustable seat posts are also affected by many drawbacks, which are briefly listed below.

Today, height adjustable seat posts are rather heavy, they weigh about 660 grams including cable, cable housing and remote control; a fixed seat post typically weighs between about 200 and 350 grams.

Height adjustable seat posts are rather complex to install and remove, therefore they require frequent maintenance.

Installation typically requires running a cable and a cable housing through the bicycle frame, mounting the remote control, attaching the cable, and adjusting the cable pull.

It is even more difficult for seat posts that are hydraulically actuated instead of cable actuated, because hydraulically actuated hoses may require bleeding the system to eliminate air bubbles.

Complexity lead to high cost: current height adjustable seat posts cost more than the average complete bicycle.

Oftentimes, an adjustable height seat post cannot be made in smaller diameters such as 27.2 mm (typical size for road bikes) because, due to its complexity, the system cannot be made this small while still passing international safety standards.

In addition, the above cited complexity to install and remove an adjustable height seat post makes it very difficult to move the seat post from bike to bike.

Most height adjustable seat posts use hydraulics to lock the post at different heights, and they require frequent rebuilds or cartridge replacement in order to keep functioning properly; more in general, all adjustable seat posts are relatively unreliable and prone to failing.

Bicycles typically have a lot of controls on the handlebars, already including shifters and brakes; some also include a shock absorber damping control. Cable and lines require maintenance, look messy, and can get caught on things: the control of a height adjustable seat post further worsens the situation.

In order to reduce the number of cables and/or hydraulic lines, “wireless” height adjustable seat posts have been recently developed.

However, such “wireless” seat posts have several disadvantages, mainly because they are heavier, more expensive, they require frequent battery charges, and most important, they are slow reacting: in fact, when the remote control is activated, there is a significant time lag between the button push and when the seat post actuates.

### SUMMARY OF THE INVENTION

The technical aim of the present invention is therefore to improve the state of the art in the field of adjustable height seat posts.

Within such technical aim, it is an object of the invention to develop an adjustable height seat post which allows to obviate the drawbacks previously complained.

Another object of the present invention is to devise an adjustable height seat post which is constructively simple and inexpensive.

A further object of the present invention is to develop an adjustable height seat post which is reliable and free from malfunctions or failures.

Still another object of the present invention is to devise an adjustable height seat post which is lighter compared to those currently on the market.

Another object of the present invention is to develop an adjustable height seat post with fast activation.

A further object of the present invention is to develop an adjustable height seat post which is easier to install and remove compared to those currently on the market, and easier to move from bike to bike.

Still another object of the present invention is to devise and adjustable height seat post free from cables, lines or remote controls.

Another object of the present invention is to develop an adjustable height seat post which requires little maintenance.

A further object of the present invention is to devise an adjustable height seat post which can be made in smaller diameters to fit road bikes, while still meeting safety standards.

This aim and these objects are all achieved by an adjustable height seat post according to the present specification.

The height adjustable seat post comprises a housing suitable to be inserted into a seat tube of a bicycle frame, and a quill comprising a head connectable to the rails of a bicycle saddle. The quill is slidably associated to the housing in order to be selectively translated from at least an upper position and a lower position, respectively corresponding to at least upper height saddle position and a lower height saddle position.

The height adjustable seat post comprises at least a slot associated to the housing or to the quill, and at least a pin associated to the quill or to the housing; the pin is slidably engaged within the slot and it is selectively engageable in a first contour of the slot corresponding to the upper position of the quill, and a second contour of the slot, corresponding to the lower position of the quill.

The height of the saddle, thanks to the solution according to the present invention, can be quickly and reliably adjusted between at least an upper position and a lower position, in a hands-free manner, by simply rotating the saddle, and therefore the quill, with legs or bottom, in order to engage/disengage the pin in the first contour or in the second contour of the slot, corresponding respectively to the upper or lower position of the quill.

The present specification refers to preferred and advantageous embodiments of the invention.

### BRIEF DESCRIPTION OF THE DRAWINGS

These and other advantages will be better understood by any man skilled in the art from the following description that follows and from the attached drawings, given as a non-limiting example, in which:

FIG. 1 is a front view of the adjustable height seat post with quill in in the upper position, according to the invention;

FIG. 2 is a front view of the seat post with quill in the upper position, with some parts removed for greater clarity;

FIG. 3 is a side view of the seat post;

FIG. 4 is a back view of the seat post;

FIG. 5 is an exploded view of the seat post;

FIG. 6 is a front view of the seat post with quill in the upper un-weighted position;

FIG. 7 is a front view of the seat post with quill in the upper weighted position;

FIG. 8 is a front view of the seat post with saddle slightly rotated by the rider;

FIG. 9 is a front view of the seat post with the saddle twisted far enough for pin to be in-line with the central rectilinear portion of the slot;

FIG. 10 is a front view of the seat post with quill about half way between upper and lower height;

FIG. 11 is a front view of the seat post with quill close to the lower height position;

FIG. 12 is a front view of the seat post with quill even closer to the lower height position;

FIG. 13 is a front view of the seat post with quill in the un-weighted lower height position;

FIG. 14 is a front view of the seat post with quill in the weighted lower height position;

FIG. 15 is a front section view of the seat post, with quill in the upper position;

FIG. 16 is a front section view of the seat post, with quill in the lower position;

FIG. 17 is a close up front view of the seat post with quill in an un-weighted upper position;

FIG. 18 is a close up front view of the seat post with quill in a weighted upper position;

FIG. 19 is a close up front view of the seat post with the saddle slightly rotated;

FIG. 20 is a close up front view of the seat post with the saddle more rotated;

FIG. 21 is a close up front view of the seat post with the saddle sliding down between the upper and the lower position;

FIGS. 22, 23 are close up front views of the seat post with the saddle mostly down;

FIG. 24 is a close up front view of the seat post with the saddle in the weighted lower position;

FIG. 25 is a close up front view of the seat post with the saddle in the un-weighted lower position;

FIG. 26 is a perspective view of the seat post according to another embodiment of the present invention, with the saddle in the lower position;

FIG. 27 is a perspective view of the seat post of FIG. 26, with the saddle in the upper position;

FIG. 28 is a perspective view of the seat post of FIGS. 26, 27, with several parts removed for greater clarity;

FIG. 29 is a perspective section view of the seat post of FIGS. 26-28, with the saddle in the lower position;

FIG. 30 is a perspective section view of the seat post of FIGS. 26-29, with the saddle in the upper position;

FIG. 31 is an exploded view of the seat post of FIGS. 26-30; and

FIG. 32 is an exploded view of a portion of the seat post according to another embodiment of the invention.

### DETAILED DESCRIPTION OF EMBODIMENTS OF THE INVENTION

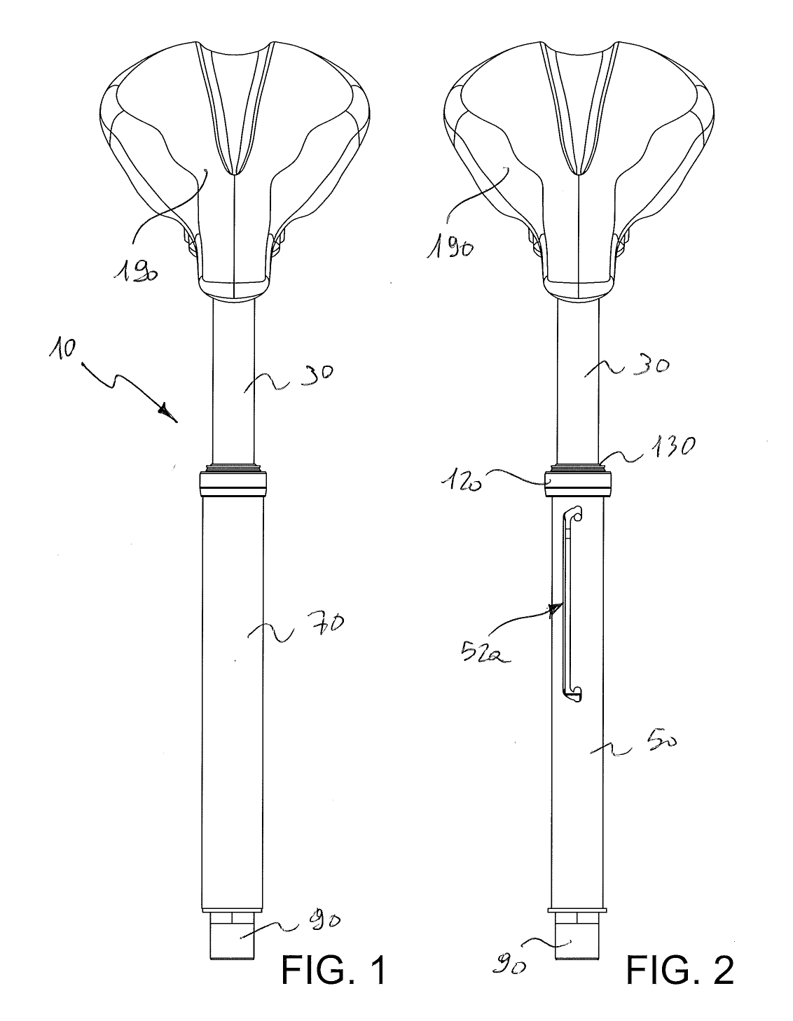

With reference to FIG. 1, an adjustable height seat post according to the invention is wholly indicated with 10.

Seat post includes a housing 70; housing 70 has tubular, or substantially tubular, shape.

Housing 70 is suitable to be inserted into a seat tube of a bicycle frame (not shown in the drawings).

Housing 70 provides structure to the seat post 10: in other words, it provides the necessary resistance and stability features for a correct and reliable use.

Seat post 10 further includes a slot guide 50; slot guide 50 is inserted within the housing 70.

Slot guide 50 has tubular, or substantially tubular, shape.

When housing 70 is clamped in a bicycle frame, housing 70 and slot guide 50 become fixed to the bicycle frame itself.

Slot guide 50 is closed at the base by a lower cap 90.

Seat post 10 includes a quill 30.

Quill 30 comprises a head 12, for connection to the rails 192 of a saddle 190 (FIG. 3).

Saddle 190 is not part of the adjustable seat post 10 according to the present invention.

Quill 30 is inserted within the slot guide 50 (see for example FIGS. 15, 16).

Quill 30 has tubular, or substantially tubular, shape.

The shape of the cross section of quill 30, slot guide 50 and housing 70 can be any.

Head 12 comprise a base 14 fixed to the quill 30, and clamping means 16 engaging the rails 192 of saddle 190.

Clamping means 16 may be such as to allow saddle 190 tilt adjustment.

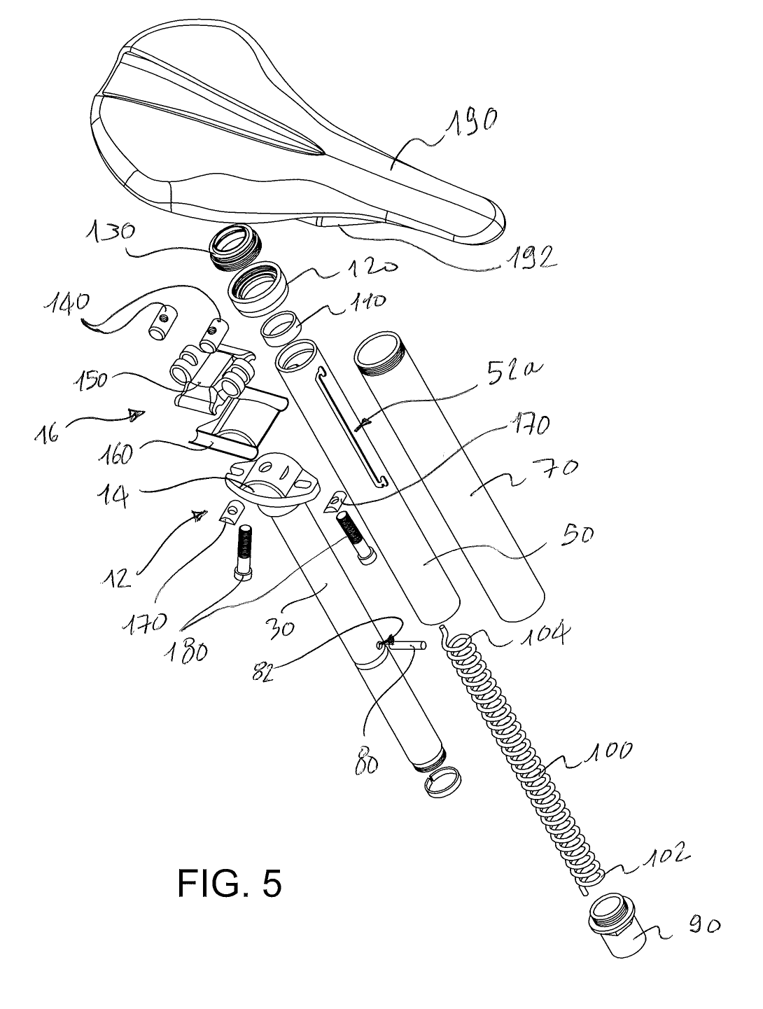

Clamping means 16 include, for example, a lower cradle 160 and an upper cradle 150, reciprocally connected in order to engage rails 192 from opposite sides. The lower cradle 160 and the upper cradle 150 are reciprocally connected by means of screws 180, curve washers 170 and barrel nuts 140 assembled in the way shown in FIG. 5.

More in general, clamping means 16 can be of any kind and design suitable to securely connect the saddle 190 to the quill 30.

Quill 30 (bearing the saddle 190) can be intentionally selectively moved, with respect to slide guide 50, from an upper position to a lower position, and vice versa.

More in detail, and according to an aspect of the present invention, quill 30 can be intentionally selectively twisted and moved, with respect to slide guide 50, from said upper position to said lower position, and vice versa.

According to an aspect of the invention, quill 30 includes at least a pin 80.

Pin 80 is engaged in a respective hole 82 of quill 30.

Through hole 82 has it respective axis arranged along a section diameter of quill 30.

A terminal portion of pin 80 partially protrudes from the lateral outer surface of quill 30.

According to another aspect of the invention, slide guide 50 includes at least one slot 52a, 52b; pin 80 is slidably engaged within said at least one slot 52a, 52b.

More in detail, in the embodiment of the invention shown in the figures, hole 82 is, more particularly, a through hole 82, and pin 80 has two opposite terminal portions, protruding from the lateral outer surface of quill 30.

In this embodiment of the invention, slide guide 50 includes two slots 52a, 52b, and in particular a first slot 52a and a second slot 52b.

The first slot 52a and the second slot 52b are diametrically opposed.

Each of the terminal portions of pin 80, therefore, slidably engages a respective first slot 52a and second slot 52b.

As shown in FIGS. 15, 16, and according to another aspect of the invention, seat post 10 includes at least a spring 100.

Spring 100 is of the helical cylindrical kind.

Spring 100 is inserted within quill 30; more in detail, spring 100 has a first end 102 (in use, the lower end) abutting lower cap 90, and a second end 104 (in use, the upper end) abutting pin 80 (the portion of pin 80 within quill 30).

As a consequence, spring 100 constantly biases quill 30 (with saddle 190) upwards.

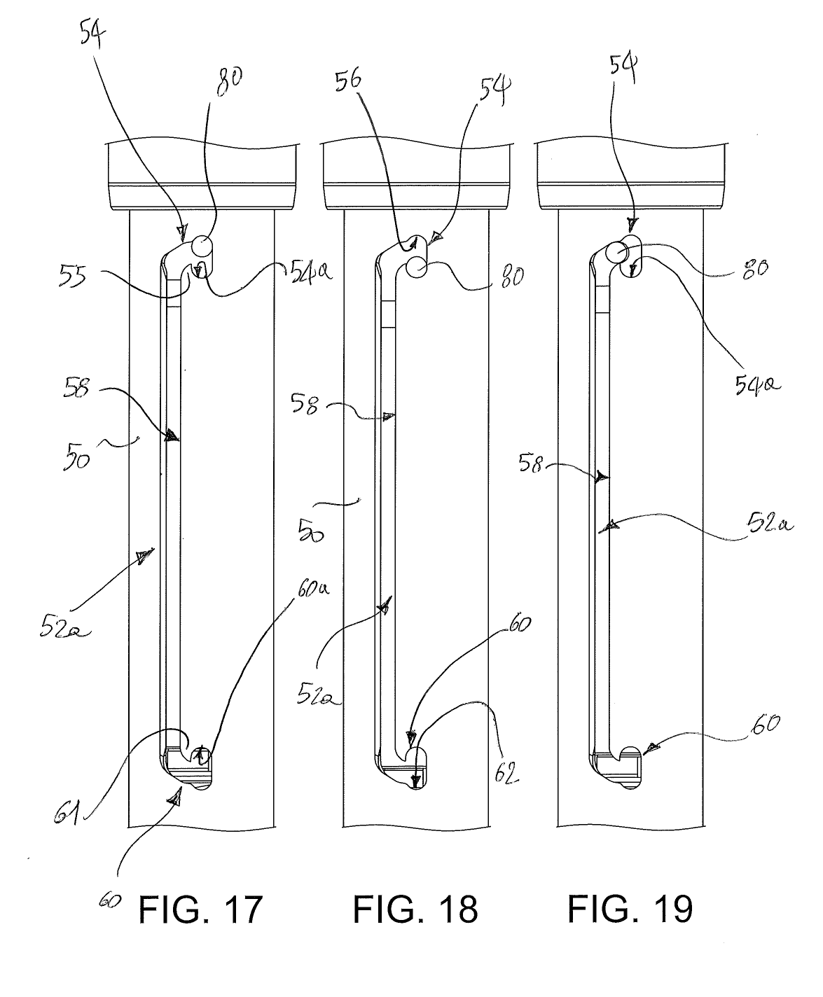

The shape of the slots 52a, 52b can be seen in detail, for example, in FIGS. 17-25 (in particular, the first slot 52a).

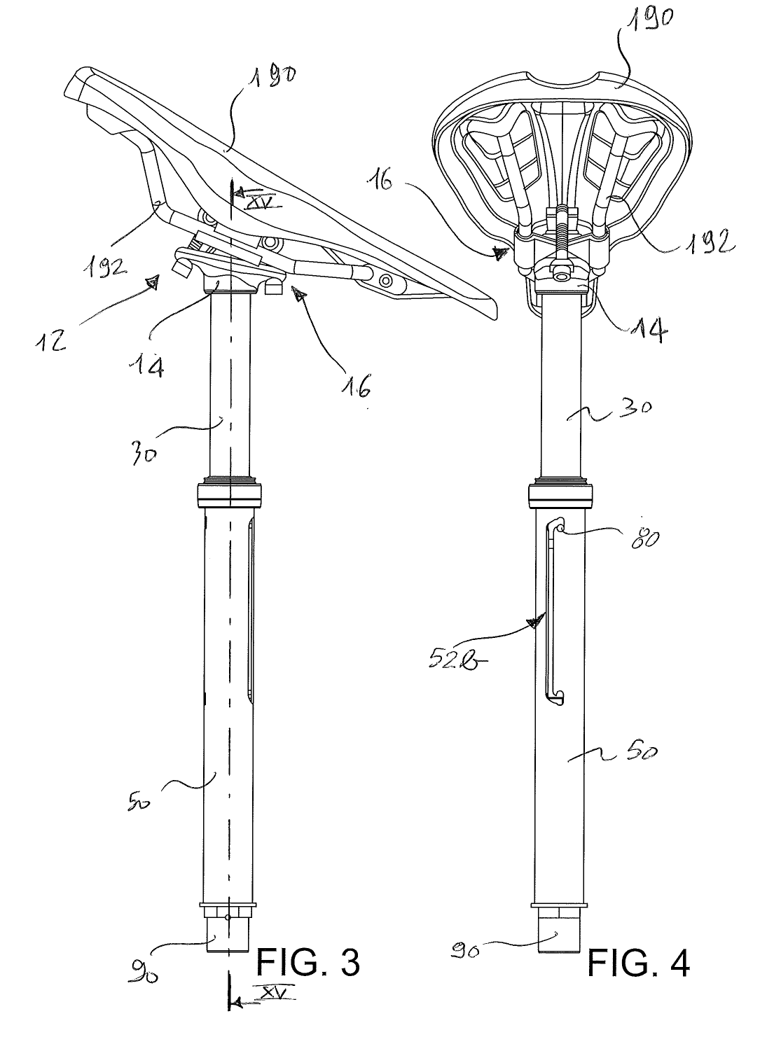

The second slot 52b can be seen, in particular, in FIG. 4.

The second slot 52b is identical to the first slot 52a, and can be ideally achieved by rotating the first slot 52a by 180° around the axis of the slot guide 50. In other words, the first slot 52a and the second slot 52b have an anti-specular arrangement with respect to a diametric section plane of slot guide 50, for the reasons discussed below.

With reference to FIGS. 17-25, each of the first slot 52a, second slot 52b, has a rectilinear central portion 58, a first contour 54 and second contour 60.

The first contour 54 and the second contour 60 communicate with the central portion 58, they are laterally arranged with respect to the central portion 58 and they are specular with respect to a plane perpendicular to the axis of the slot guide 50.

More in detail, the first contour 54 includes a first proximal portion 54a, and a first distal portion 56.

The terms proximal and distal refer to the central portion 58.

The first proximal portion 54a is defined by a respective first lip 55.

As well, the second contour 60 includes a second proximal portion 60a, and a second distal portion 62.

The second proximal portion 60a is defined by a respective second lip 61.

As can be seen, the first slot 52a (as well as the second slot 52b) has therefore a sort of “C” shape, thanks to the combination of the central portion 58, first contour 54 and second contour 60.

As shown in the exploded view of FIG. 5, seat post 10 further includes a top bushing 110, a ring 120 and a seal 130 for the assembly of the slide guide 50 and the housing 70, also preventing dirt penetrating inside slide guide 50.

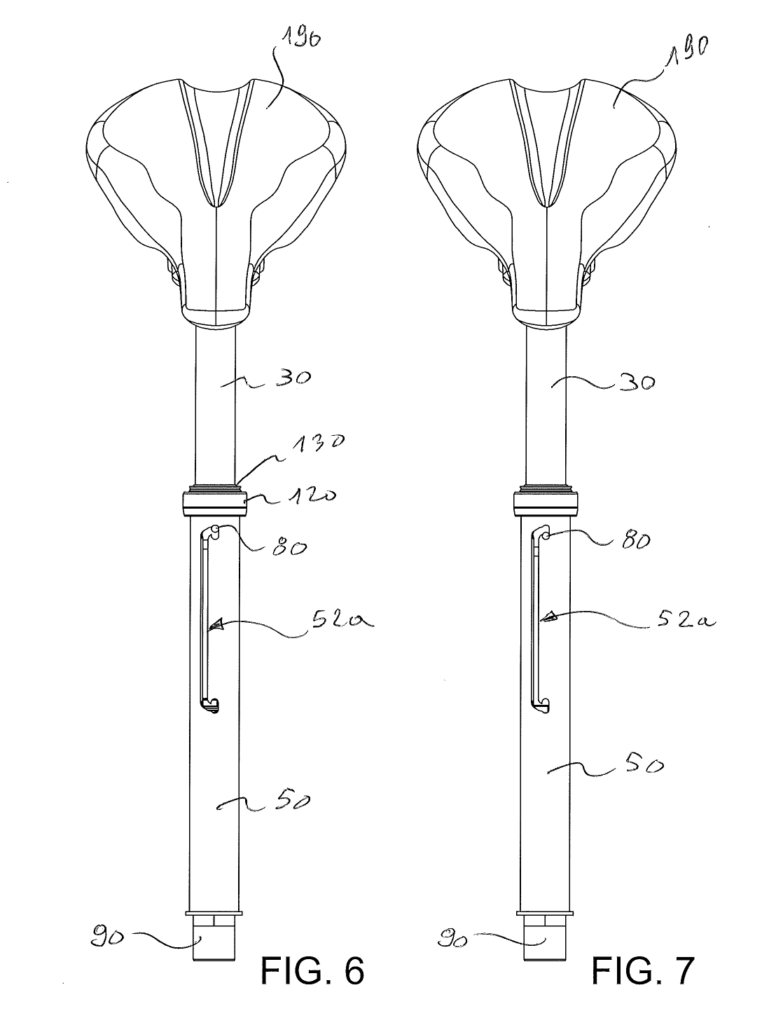

FIG. 6 shows the seat post 10 in the upper un-weighted position.

Un-weighted means that the rider is not sitting on saddle 190.

This configuration is also shown, in close up, in FIG. 17. In this position, pin 80 contacts the first distal portion 56 of the first contour 54 (of both the first slot 52a and the second slot 52b), and the saddle 190 is in a straight forwards orientation when the rider is not sitting on it.

As the rider weighs saddle 190 by sitting on it, saddle 190 lowers few millimetres until pin 80 contacts the first proximal portion 54a of first contour 54. Pin 80 follows a similar path in second slot 52b (not shown), on the back of slot guide 50.

FIG. 7 shows the seat post 10 in the upper weighted position; this configuration is also shown in the close up of FIG. 18.

In this position, pin 80 contacts the first proximal portion 54a of first contour 54, and saddle 190 is held in a straight forward position, so the seat post 10 feels to the rider like a non-height adjustable seat post; first lip 55 prevents saddle 190 from rotating towards the other portions of the first slot 52a.

In this position, saddle 190 cannot rotate unless saddle 190 is partially un-weighted, and then twisted.

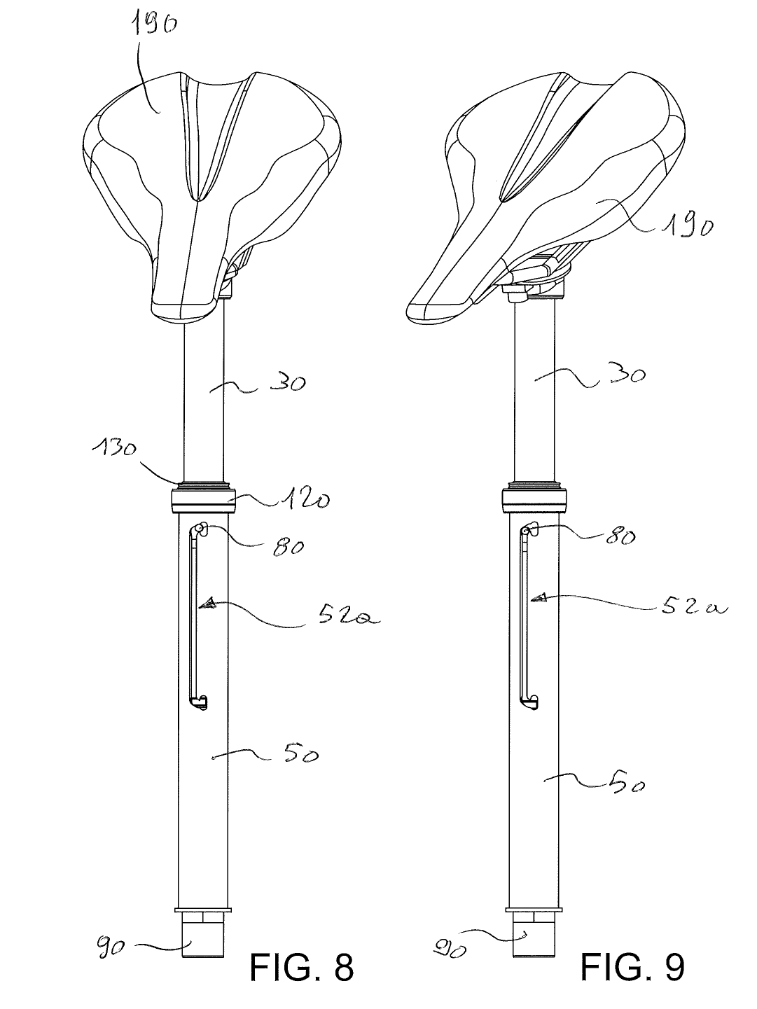

FIG. 8 shows saddle 190 slightly rotated by the rider; this configuration is also shown in the close up of FIG. 19.

In this position, pin 80 begins to travel away from the first contour 54; if the rider released saddle 190, the latter would straighten again as spring 100 causes pin 80 to travel back to first contour 54.

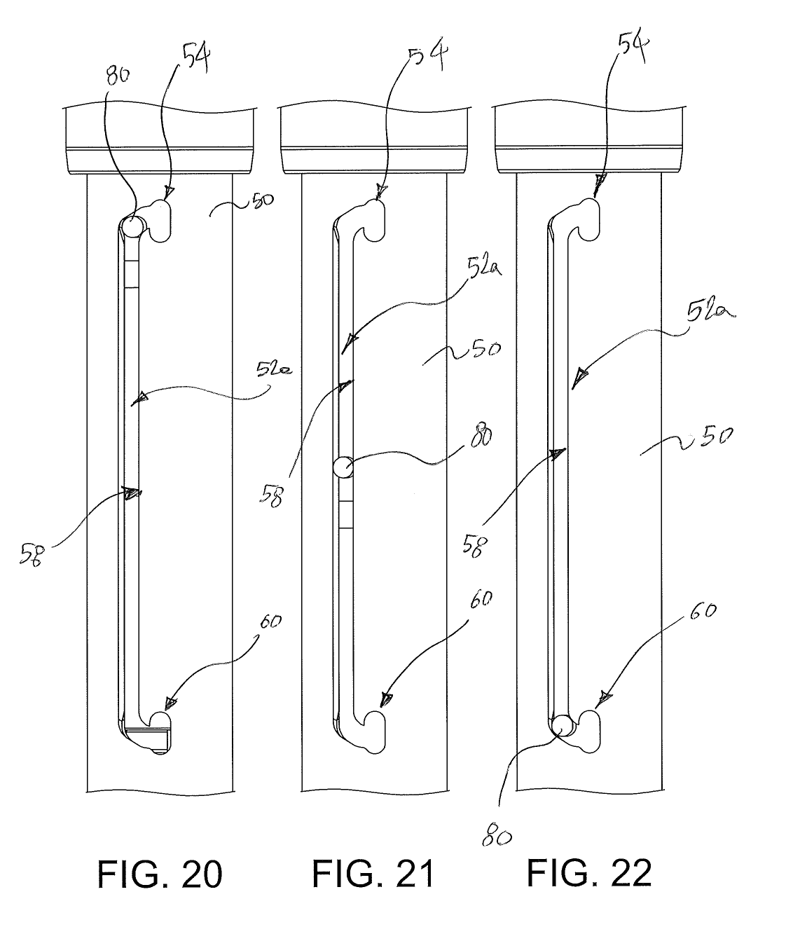

FIG. 9 shows saddle 190 twisted far enough from the straight position, so that pin 80 is in-line with the central portion 58 of the first slot 52a; this configuration is also shown in the close up of FIG. 20.

In this position, if the rider pushes downwards on saddle 190 (such as by sitting), then saddle 190 will lower as pin 80 travels down the central portion 58 of the first slot 52a.

If the rider releases saddle 190, then the latter would straighten again, as spring 100 causes pin 80 to travel back to the first distal portion 56.

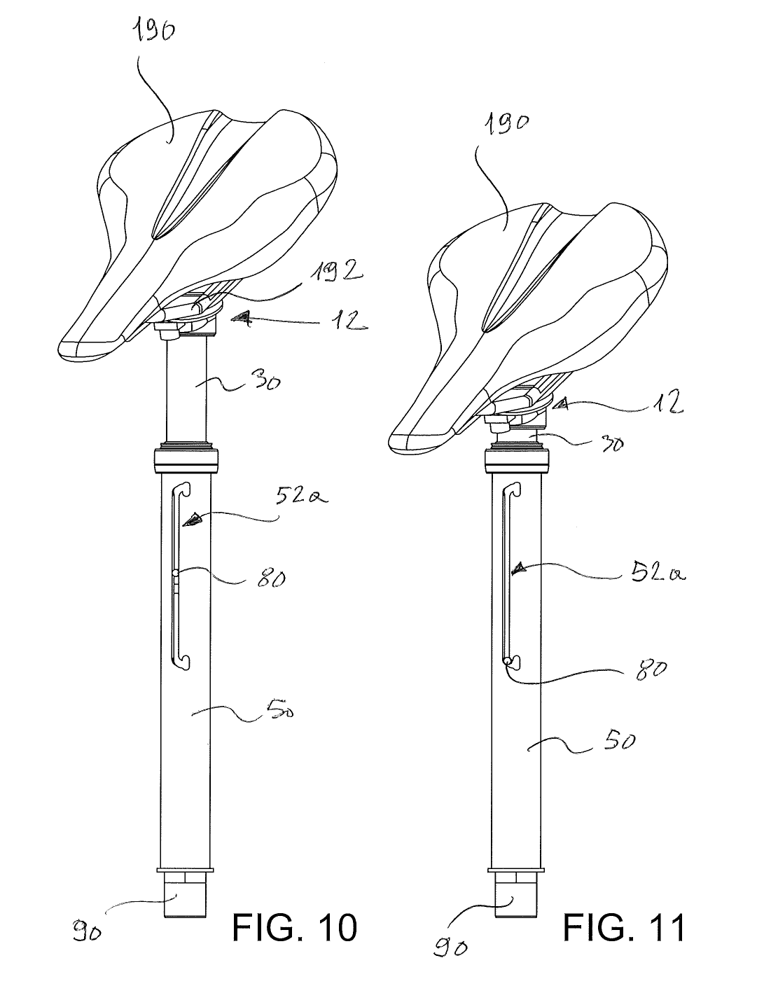

FIG. 10 shows saddle 190 (and therefore quill 30) about half way between the upper and lower position: in this situation, pin 80 is sliding along the central portion of the slides 52a, 52b.

This configuration is also shown in the close up of FIG. 21.

FIG. 11 shows saddle 190 (and therefore quill 30) close to the lower position: this configuration is also shown in the close up of FIG. 22. In this position, if the rider pushes down on saddle 190, the latter will twist into the lower position.

If the rider releases saddle 190, the latter will slide upwards and straighten again, as spring 100 causes pin 80 to travel back to the first distal portion 56.

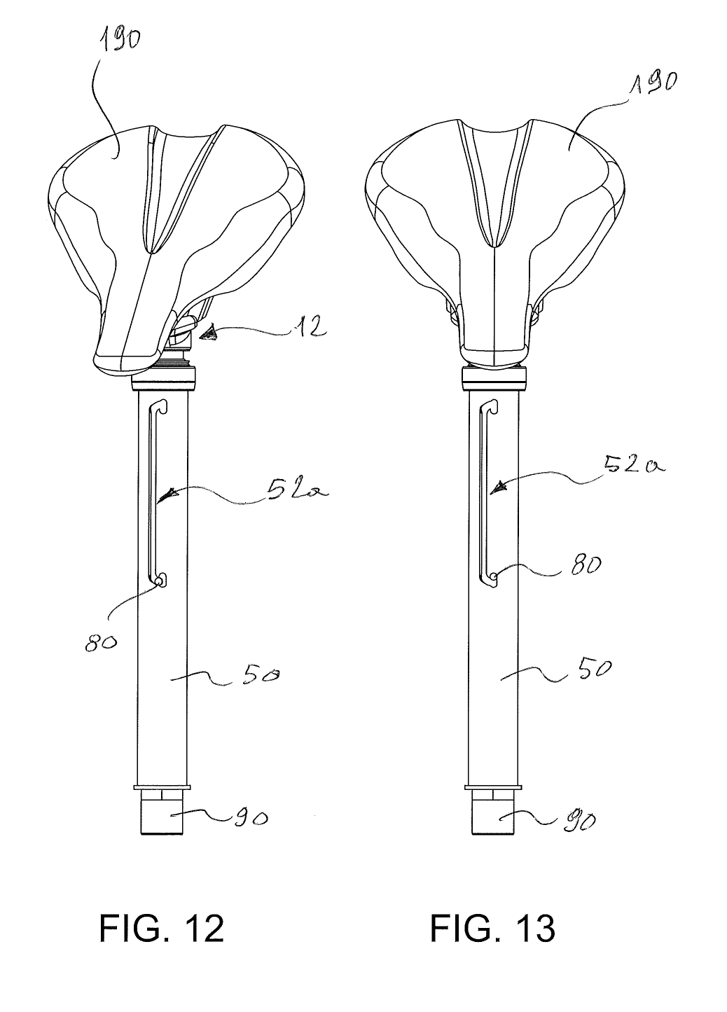

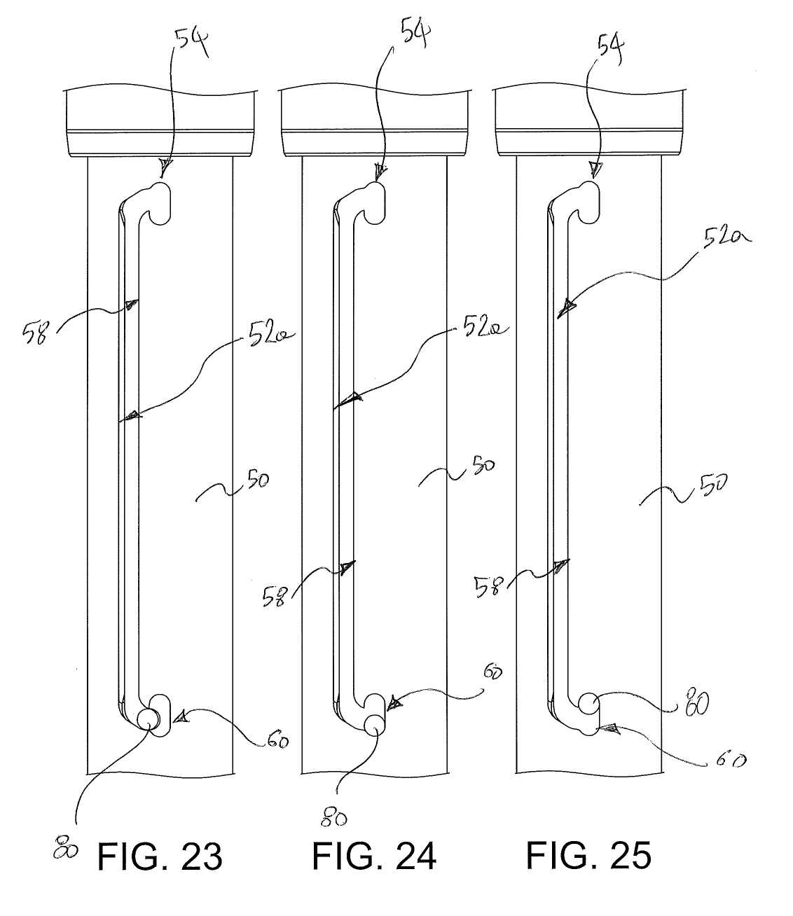

FIG. 12 shows saddle 190 (and quill 30) even closer to the lower position; this configuration is also shown in the close up of FIG. 23.

FIG. 13 shows saddle 190 (and quill 30) in the un-weighted lower position: in this position, pin 80 contacts the second distal portion 62.

This configuration is also shown in the close up of FIG. 25.

Saddle 190 cannot be rotated unless a downward force is first pushed on the latter; spring 100 is fully compressed and it keeps pin 80 firmly against first proximal portion 60a, unless the rider pushes down on saddle 190.

In this way, saddle 190 cannot accidentally move out of the lower position even if the rider is traveling over bumpy terrain.

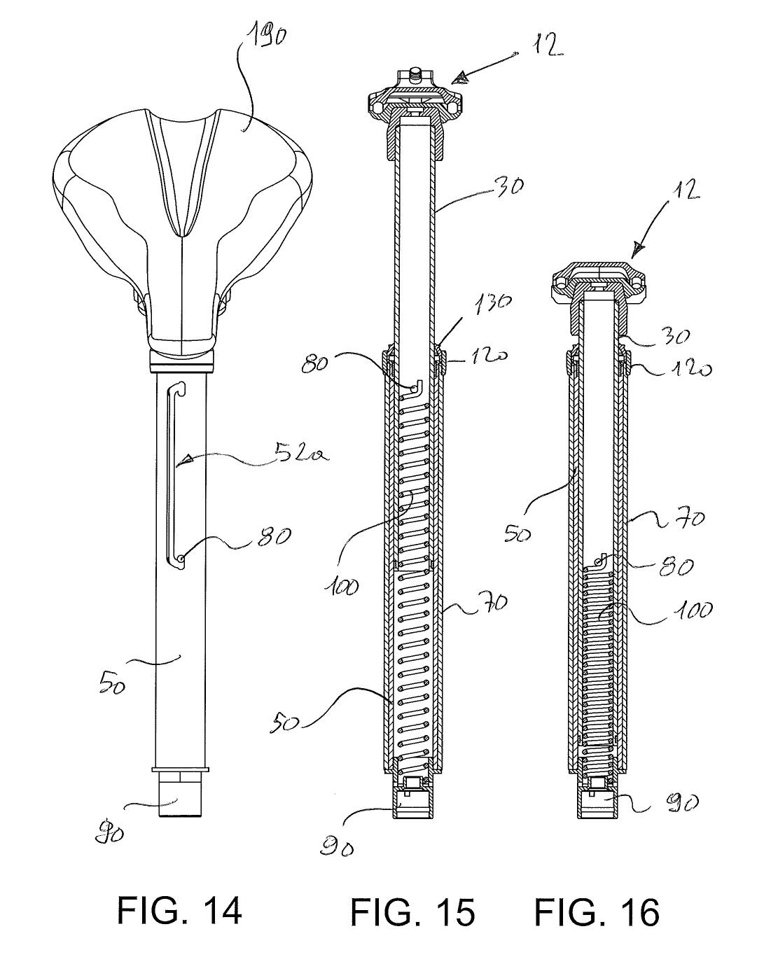

FIG. 14 shows saddle 190 (and quill 30) in the weighted lower position; this configuration is also shown in the close up of FIG. 24.

In this position, pin 80 contacts the second distal portion 62 of the second contour 60.

In this way the rider can sit on saddle 190 and coast or pedal while saddle 190 is in the lower position, and seat post 10 feels like a non-height adjustable version.

If the rider unweights saddle 190 (for example he stands up), saddle 190 will slightly rise as pin 80 contacts the second proximal portion 60a, and saddle 190 will remain straight ahead.

FIG. 15 shows a section of the seat post 10 taken along plan XV-XV of FIG. 3; quill 30 is in the upper position.

Spring 100 is extended as much as it is allowed, and it provides a preload upwards.

Spring 100 is both a compression and torsion spring.

Seat post 10 could also work if spring 100 is simply a compression spring.

As a compression spring, spring 100 biases saddle 190 to be straight ahead because of the ramps and contours of slots 52a and 52b.

However, in order to additionally bias saddle 190 forwards, as lower cap 90 is engaged into slot guide 50, spring 100 is preloaded torsionally, since pin 80 prevents the first end 102 of spring 100 from turning.

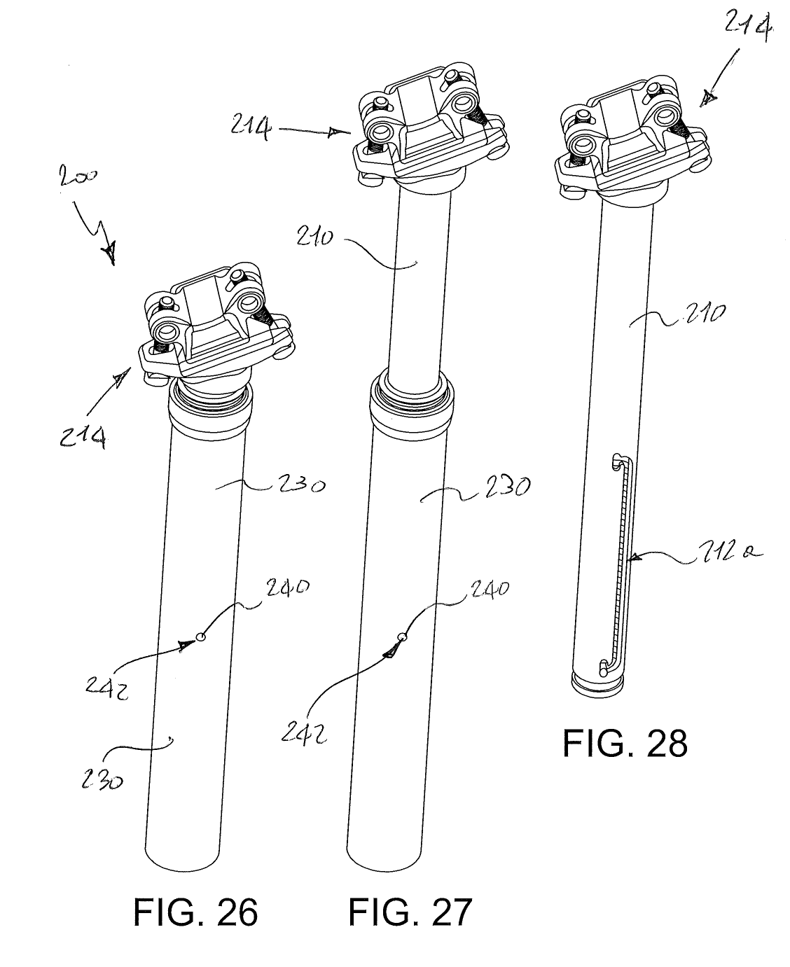

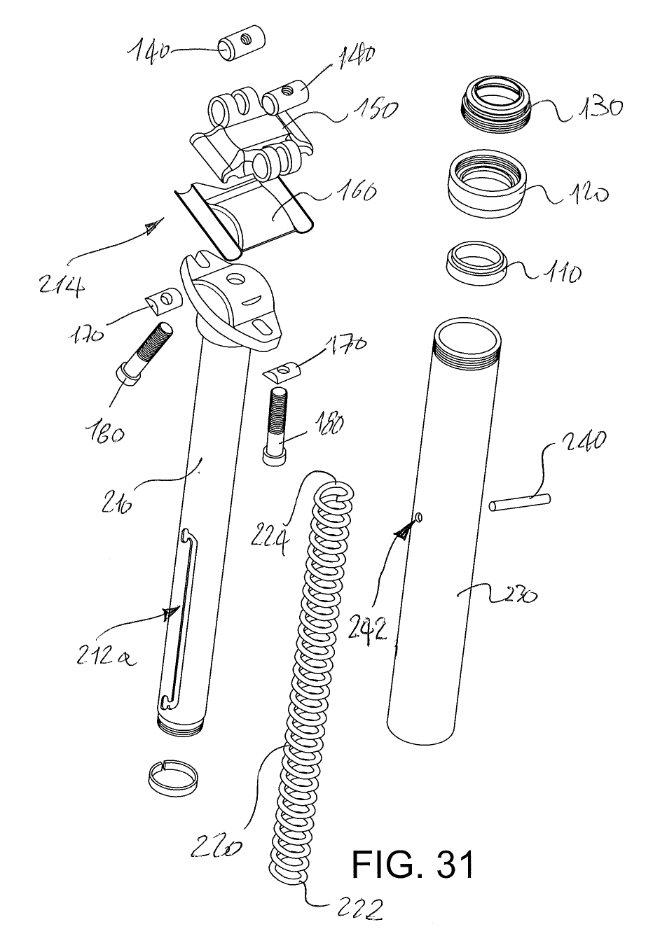

In FIG. 16, quill 30 is in the lower position, and spring 100 is compressed. Another embodiment of the adjustable height seat post 200 according to the invention is shown in FIGS. 26-31.

This embodiment of the invention is even simpler and lighter than the previous one, because it includes fewer parts.

In this embodiment, seat post 200 includes a quill 210 having a first slot 212a and a second slot 212b.

First slot 212a and 212b have the same shape and positioning that they have in the slot guide 50 of the previous embodiment.

Seat post 200 further includes a housing 230, inside which quill 210 is inserted.

Housing 230 has tubular, or substantially tubular, shape.

Housing 230 includes a pin 240; pin 240 is engaged in a respective through hole 242 of the housing 230.

Seat post 200 further includes a spring 220; more in detail, spring 220 is a compression spring.

Spring 220 is housed inside quill 210, and abuts pin 240; more in particular, spring 220 has a first end 222 abutting pin 240, and a second end 224 abutting head 214 of quill 210.

Seat post 200 further includes bushings 250,260, allowing quill 210 to slide inside housing 230, a ring 120 and a seal 130.

FIG. 26 shows seat post 200 in the lower position; FIG. 27 shows seat post 200 in the upper position.

FIG. 28 shows seat post 200 with housing 230 removed, for greater of clarity.

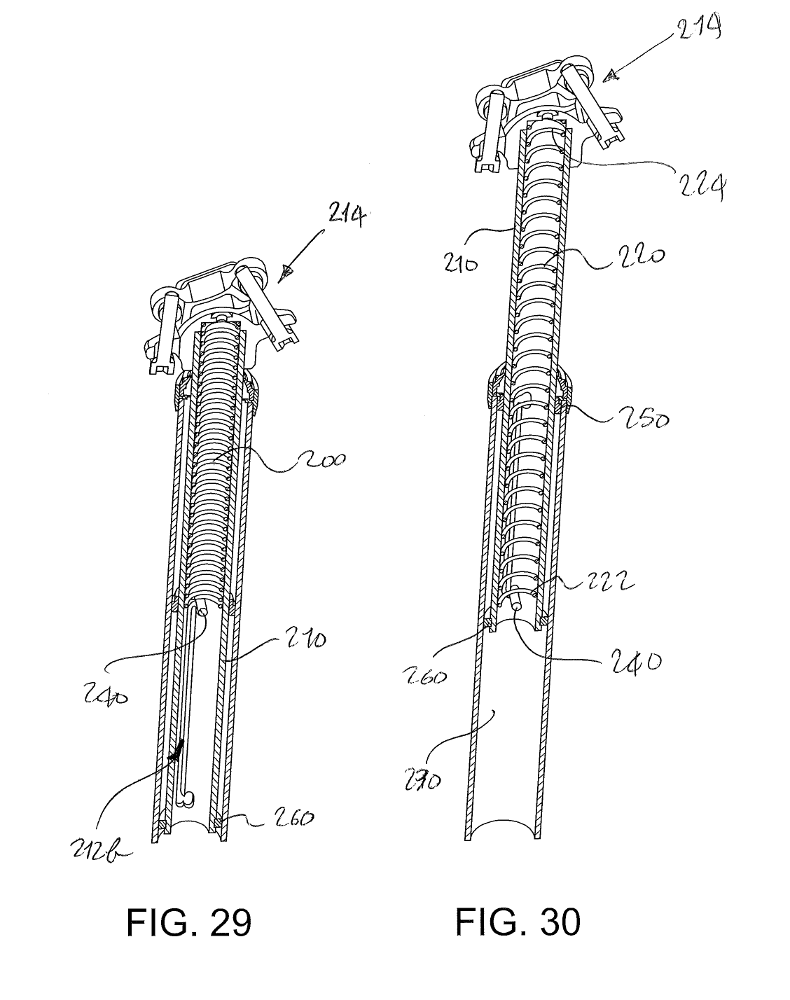

FIG. 29 shows a section view of seat post 200 in the lower position, in which compression spring 220 is compressed, while FIG. 30 shows a section of seat post 200 in the upper position.

While the bottom of quill 210 is shown aligned with the bottom of housing 230 (FIG. 29), it would be possible for quill 210 to protrude beyond the bottom of housing 230 if bushing 260 were located higher on quill 230, to provide good stability.

In this way, it would be possible to make seat post 200 even lighter.

Also, there is no need for a lower cap at the bottom of the housing.

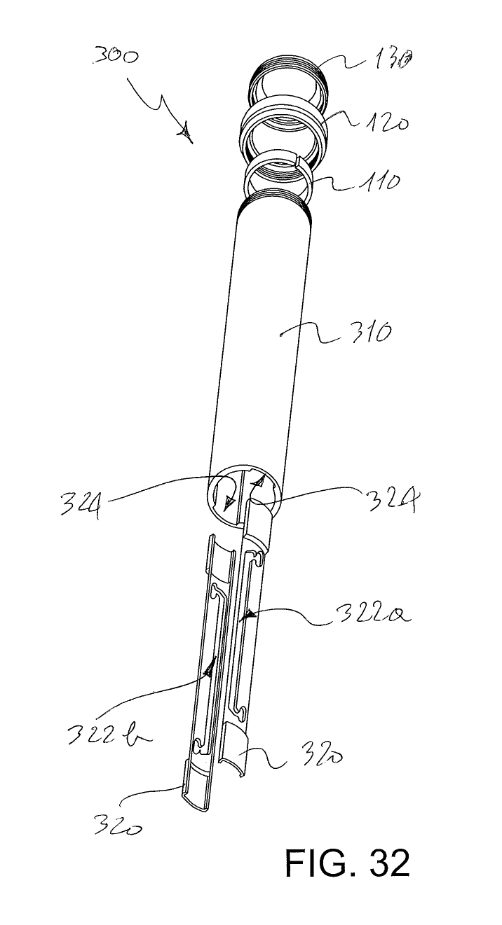

Another embodiment of the seat post 300 according to the invention is shown in FIG. 32.

This embodiment is similar to the first one disclosed (FIGS. 1-25), and it differs in that it comprises two slot inserts 320 instead of a guide slot 50.

Slot inserts 320 fit into housing 310; slot inserts 320 include respective first and second slots 322a, 322b, identical to first and second 52a, 52b disclosed in the first embodiment of the seat post 10.

Slot inserts 320 are engaged in respective groves 324 made in the inner surface of housing 310.

Slot inserts 320 could be made of an especially strong material such as steel without adding as much weight.

Housing 310 could be made, for example, of extruded aluminium or carbon fiber.

Slots 52a,52b,212a,212b,322a,322b are disclosed as having only an upper and a lower position. In some embodiments of the invention, slots 52a,52b,212a,212b,322a,322b could be modified in order to include intermediate positions too.

Spring 100,220 could also be of other kinds, for example an air spring, an elastomer, or an extension spring.

While pins 80,240 are shown as round cylinders, they could be realized with other shapes, for example diamond shaped or rectangular.

The number of pins 80,240 could be any: for example, there could be two pins 80,240 perpendicular to each other and four guide slots 50.

The embodiments shown require a clockwise rotation for activation, but the rotation could be also counterclockwise instead.

It would even be possible to design the seat post so that it would be possible for the rider to select the preferred rotation by simply flipping over the guide slot 50, or the slot inserts 320.

The embodiment shown have about 100 mm change in height between the upper position and the lower position, but it would be easy to modify the designs to achieve shorter or longer travel lengths.

The seat post 10,200,300 according to the present invention allows achieving various technical advantages.

The seat post 10,200,300 is hand-free, as it does not include any cable, cable housing, or remote control. It is self-contained, and activation—which is simple and fast—is accomplished by the rider's legs and/or bottom.

The seat post 10,200,300 is lighter than adjustable seat post currently on the market, at least 100 grams lighter using similar materials: eliminating the cable, cable housing and remote control saves about 70 grams.

The seat post 10,200,300 is easier to install and remove from a bicycle frame as any fixed seat post, so it can be shared between several bikes.

The seat post 10,200,300 is simpler than those currently on the market, and therefore more reliable; it can also be made in smaller diameters, to fit road bikes while still meeting safety standards.

Last but not least, the seat post 10,200,300 is cheaper than those currently on the market, because it has fewer parts; therefore, it could also be installed on affordable bike models.

Saddle 190 is stable in a forwards position when the rider is seated, and it can be easily twisted by legs or bottom to allow the seat height to change.

With only a few minutes of practice, a rider can learn to comfortably move the saddle 190 up and down.

In the embodiments disclosed hereafter individual features, given in connection with such specific embodiments, may actually be interchanged with other different features that exist in other embodiments.

The present invention has been described according to preferred embodiments, but equivalent variants can be devised without departing from the scope of protection offered by the following claims.

1. A height adjustable seat post comprising a housing suitable to be inserted into a seat tube of a bicycle frame, and a quill comprising a head connectable to the rails of a bicycle saddle, said quill being slidably associated to said housing in order to be selectively translated from at least an upper position and a lower position, respectively corresponding to at least upper height saddle position and a lower height saddle position, further comprising at least a slot associated to said housing or to said quill, and at least a pin associated to said quill or to said housing, said pin being slidably engaged within said slot and being selectively engageable into a first contour of said slot corresponding to said upper position of said quill, and into a second contour of said slot, corresponding to said lower position of said quill.

2. The seat post according to claim 1, in which the selective engagement of said pin within said first contour or said second contour is achieved by rotating said quill within said housing, said rotation being imparted by user's legs and bottom.

3. The seat post according to claim 1, in which said slot comprises a rectilinear central portion, a first contour and a second contour, opposite to each other and communicating with said central portion.

4. The seat post according to claim 3, in which said first contour and second contour are laterally arranged with respect to said central portion, so as to define respective ramps, and they are specular with respect to a plane perpendicular to the axis of said housing.

5. The seat post according to claim 3, in which said first contour includes a first proximal portion and a first distal portion, said first proximal portion being defined by a first lip, said first proximal portion corresponding to a weighted upper position of said quill, said first distal portion corresponding to a un-weighted upper position.

6. The seat post according to claim 3, in which said second contour includes a second proximal portion and a second distal portion, said second proximal portion being defined by a respective second lip, said second proximal portion corresponding to an un-weighted lower position, said second distal portion corresponding to a weighted lower position.

7. The seat post according to claim 1, in which said housing comprises a first slot and a second slot, which are diametrically opposed, said second slot being ideally achieved by rotating said first slot by 180° around the axis of said housing.

8. The seat post according to claim 1, comprising at least a slot guide inserted within said housing, said slot guide including said at least one slot.

9. The seat post according to claim 1, comprising a spring suitable to push said quill upwards in configuration of use.

10. The seat post according to claim 9, in which said spring is inserted inside said quill.

11. The seat post according to claim 9, in which said spring can be a helical cylindrical spring, an air spring, an elastomer.

12. The seat post according to claim 1, in which said pin is engaged in a through hole realized in said quill.

13. The seat post according to claim 1, in which said pin is engaged in a respective through hole of said housing, and in which said slots are included in said quill.

14. The seat post according to claim 1, in which said housing includes two diametrically opposite slot inserts, comprising respective slots, engaged in respective grooves made in the inner surface of said housing.

15. The seat post according to claim 1, in which said spring has a first end abutting a lower cap of said housing, and a second end abutting said pin.

16. The seat post according to claim 13, in which said spring has a first end abutting said pin, and a second end abutting said head of said quill.

17. The seat post according to claim 1, in which said slot includes a plurality of intermediate positions or contours corresponding to respective intermediate position of said quill with respect to said housing.

18. The seat post according to claim 1, in which said pin is shaped as a round cylinder, or it is diamond-shaped, or it is rectangular-shaped.
